(19) United States
(12) Patent Application Publication
(10) Pub. No.: US 2008/0092083 A1
(43) Pub. Date: Apr. 17, 2008

(54) Personal viewing device

(76) Inventors: David Dutton, San Jose, CA (US); Richard L. Baer, Los Altos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/546,434

(22) Filed: Oct. 12, 2006

(51) Int. Cl. G06F 9/00

(52) U.S. Cl. 715/848

(57) ABSTRACT

A method of using a personal viewing device that has a display includes sensing a coordinate and an attitude of the personal viewing device and then calculating display data based on stored object data, the coordinate and the attitude. The method further includes displaying on the display a representation of the object in response to the display data.

### BACKGROUND OF THE INVENTION

### Description of Related Art

As computer processor density increases, the size of personal computing continually decreases. Personal Digital Assistants (PDA's) and cell phones are becoming general purpose computers that are getting smaller and smaller. The reduction in size of electronics to fit small form factors is no longer the predominant limiting factor, but instead, the display size now becomes a limiting factor. The questions are now—“is the screen big enough to display the information?” and “how do you navigate information on such a small display?”

For conventional desktop and laptop computers, users coordinate both visual focus and the location of a pointer on a large static viewing field. For small form factors systems, such as cell phones, PDAs and personal game systems, the display field is close to the size of the user's visual focus To make a bigger virtual viewing area, current schemes move the smaller display field relative to a larger virtual image once the pointer has moved to the edge of the display or the user moves the viewing field relative to the larger virtual image using simple direction control buttons.

Displaying of 3D information on a 2D display makes use of viewing planes and cross sections. Examples of 3D information are engineering drawings, mathematical models or a investigative scan of the human body (MRI for example). Cross sections are conventionally displayed in succession on a single display, or by an array of smaller cross sections shown in parallel on a much larger display. More advanced techniques display the outline of the volume to be investigated on a 2D display and highlight the cross section of a plane that is under control by the user. Co-ordination between a separate pointing device (or commands), the perceived viewing field and attitude, and the output display require an experienced user.

### SUMMARY OF THE INVENTION

A personal viewing device includes a display. Using the device includes sensing a coordinate and an attitude of the device and calculating display data based on stored object data, the coordinate and the attitude. The display data is then used to display a representation of the object on the display.

### BRIEF DESCRIPTION OF DRAWINGS

The invention will be described in detail in the following detailed description with reference to the following figures.

FIG. 1 is a schematic of a geometry of a hand held device in relation to a virtual object.

FIG. 2 is a block diagram depicting an embodiment of the invention.

FIG. 3 is a schematic of another geometry of a hand held device in relation to a virtual object.

FIG. 4 is a schematic of yet another geometry of a hand held device in relation to a virtual object.

FIG. 5 is a flow chart depicting an embodiment of the invention.

### DETAILED DESCRIPTION

With a personal window device, a user experiences a personal window through which to view a larger virtual viewing area. In an embodiment of the invention, a small personal window device, with an integrated display and a coordinated tracking device, permits a user to view on the display a sub area of a larger virtual viewing area. A simple embodiment of this technology uses an optical navigation device as is used in a computer mouse. An advanced embodiment of this technology, that would open up the viewing experience into three dimensions, is enabled through use of current gyroscope technology or other three-dimensional sensor technologies.

With either embodiment, a two-dimensional display surface of the personal window device becomes a personal window for viewing a larger virtual viewing area/volume. As a user moves the personal window device about a two-dimensional surface or within a 3D volume, the display presents a new part of the virtual viewing area defined by the position history of the personal viewing device.

The personal window can be analogized to a magnifying lens which the user moves over the surface of the object to be viewed. Here, the position of the lens (personal window) becomes the focus of visual attention. The function of the magnifying lens is to increase the image size of the portion of the surface currently being viewed.

In the case of the “personal window,” the function of the personal window is to display an image of the portion of the virtual viewing area corresponding to the specific position of the personal window device on the surface or in the volume. For the 2D case, the personal window device can transform an empty two-dimensional surface into the desktop conventionally displayed on a computer. A display having the size of a cell phone screen could be used to easily navigate this desktop by running it across a two-dimensional surface such as a table top or a book.

Navigation and viewing are coordinated in the same unit so that the user can intuitively wander around the virtual viewing area. Having a 1:1 relationship between the position of the personal window device and viewing, the user will become familiar with and confident within the virtual viewing area. For example, if the user moves the personal window device over a virtual desktop and views a folder located near the top left of the virtual desktop, the user can either choose to open the folder or move the personal window elsewhere. Even if the user moves the personal window elsewhere, the user now knows where that folder is in the two-dimensional space of the virtual viewing area. The user will be more easily able to return to that point in the virtual viewing area than using a pointing device (computer mouse) separated from the personal window of the personal window device.

By locating an optical navigation device on the back of a cell phone (or other small display with buttons), opposite the display screen, a modified cell phone can be used to provide the personal window device that accesses a two-dimensional virtual viewing area much larger than the cell phone's display. For example, the user can easily navigate a virtual desktop computer screen or a virtual map of the world. In some embodiments, the personal window device is equipped with buttons that provide a re-centering function and a hold function such that a user can reach a larger virtual space within a limited physical space.

In a first embodiment of a personal viewing device, the device includes a sensor operable to sense a coordinate and an attitude of the personal viewing device and a processor operable to calculate display data in response to stored object data representing an object, the coordinate and the attitude. The personal viewing device also includes a display coupled to the processor operable to display an image of the object based on the display data.

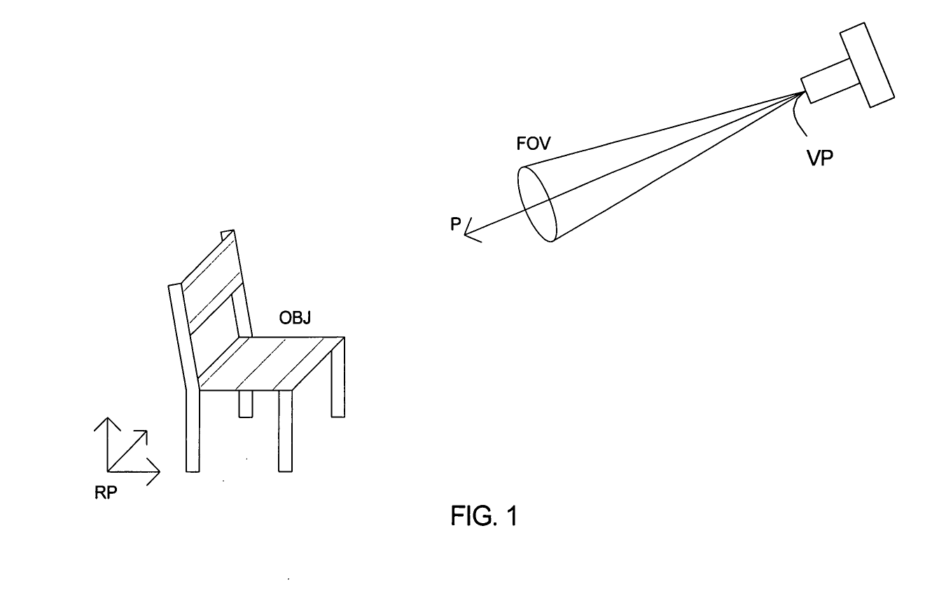

FIG. 1 depicts a typical geometry of a virtual object OBJ and a vantage point VP. Virtual object OBJ, a chair as depicted in FIG. 1, is referenced to reference point RP that includes a coordinate system having one, two or three dimensions to orient the virtual object. Vantage point VP is selected in a number of ways as described herein. An orientation for the viewing of object OBJ is defined by an attitude depicted in FIG. 1 as pointing parameter(s) P. Pointing parameter(s) P includes one, two or three attitude parameters, typically yaw, pitch and roll when three parameters are used. The magnification of the image of virtual object OBJ as seen on a display of a personal viewing device is governed by a field of view FOV as discussed further herein.

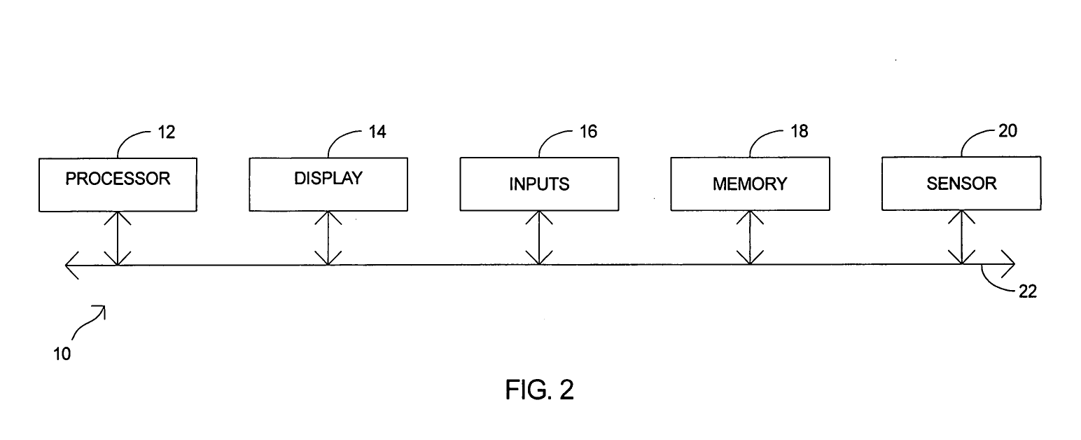

A first example of the first embodiment is depicted in part of FIG. 2. In FIG. 2, a personal viewing device 10 includes a sensor 20 operable to sense a coordinate (VP relative to RP in FIG. 1) and an attitude (P in FIG. 1) of the personal viewing device and a processor 12 operable to calculate display data in response to stored object data representing an object (OBJ in FIG. 1), the coordinate and the attitude. Personal viewing device 10 also includes a display 14 coupled to processor 12 over bus 22. Display 14 is operable to display an image of object OBJ based on the display data.

A second example of the first embodiment is depicted in a further part of FIG. 2. In FIG. 2, personal viewing device 10 further includes circuitry as part of inputs 16 operable to receive object data and a memory 18 operable to store the object data as the stored object data. The circuitry operable to receive object data may be based on any known technology such as a direct wire link (e.g., ether net (LAN), firewire, USB, etc.), infrared link, or RF link (e.g., wireless LAN (802.11 b,g) or Blue Tooth) or any yet to be known equivalent.

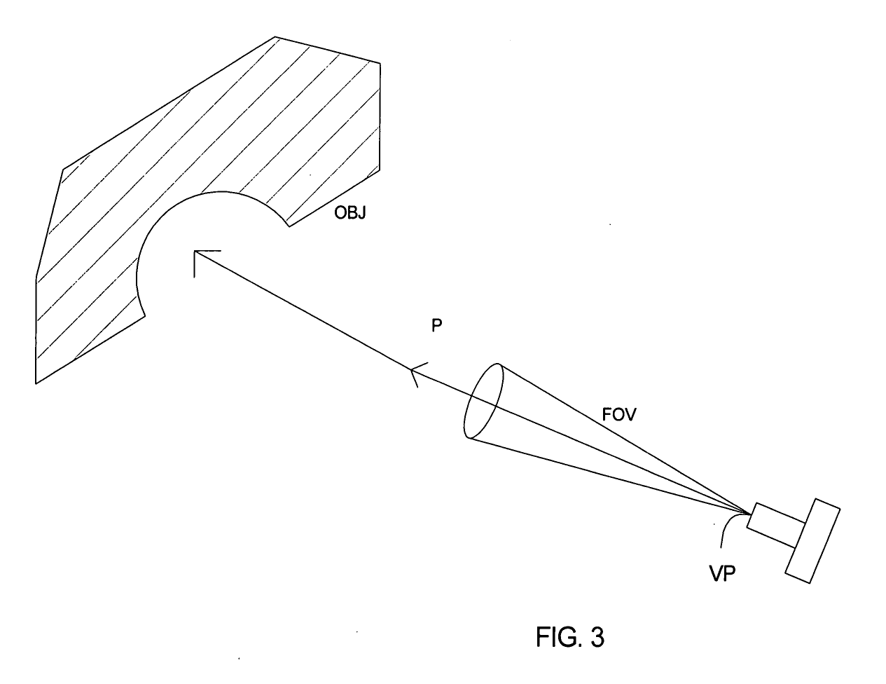

A third example of the first embodiment is exemplified in FIG. 3. In this third example, the coordinate is a single dimension coordinate VP and the attitude is fixed in direction P. In FIG. 3, a virtual tunnel is depicted as the object OBJ and the vantage point VP is a coordinate along a fixed attitude P.

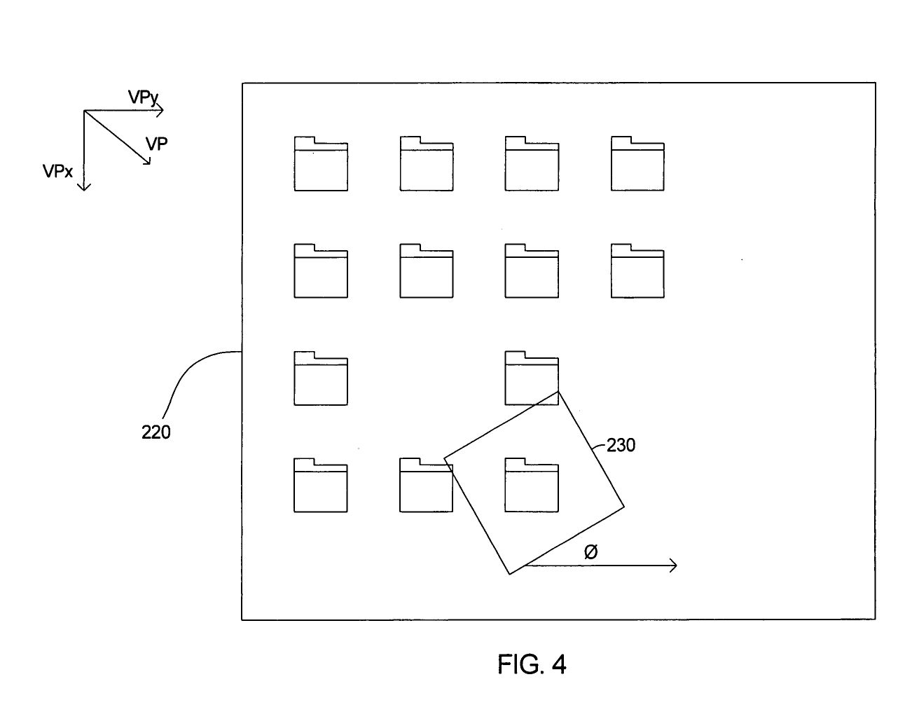

A fourth example of the first embodiment is exemplified in FIG. 4. In this fourth example, the coordinate is a coordinate in no more than two dimensions (e.g., x and y directions) and the attitude is a rotation metric about no more than one axis (e.g., a roll axis about an axis passing through the x, y plane). In FIG. 4, a virtual computer desktop display in two dimensions is depicted as the object OBJ and the vantage point VP (not shown) is the coordinate in two dimensions. The attitude is the rotation metric depicted in FIG. 4 as a 45 degree CCW rotation.

A fifth example of the first embodiment is exemplified in FIG. 1. In this fifth example, the coordinate is a coordinate in three dimensions (e.g., x, y and z), and the attitude is a rotation metric about three axes (e.g., yaw, pitch and roll).

A sixth example of the first embodiment is exemplified in FIG. 4. In this sixth example, the coordinate comprises a two-dimensional coordinate; and the attitude comprises a two-component attitude. The roll component is depicted in FIG. 4. A second attitude component will be called tilt. The tilt component of the attitude will enable the viewing plane to be tilted from zero degrees (as depicted all the way up to 90 degrees to enable the personal viewing device to look across the surface of the virtual surface.

A seventh example of the first embodiment is exemplified in FIG. 1. In this seventh example, the coordinate comprises a three-dimensional coordinate and the attitude comprises a three-component attitude.

An eighth example of the first embodiment is exemplified in FIG. 1. In this eighth example, processor 12 is further operable to define a field of view FOV and the processor that is operable to calculate display data is operable to compute the display data in response to field of view FOV and from a point of view located at the coordinate VP looking along a line of sight defined by the attitude P.

A ninth example of the first embodiment is exemplified in FIG. 1. In this ninth example, processor 12 is further operable to define a vantage point along a line of sight that passes through the coordinate VP and that is defined by the attitude P and processor 12 that is operable to calculate display data is operable to compute the display data to represent the stored object data as viewed from the vantage point looking along the line of sight.

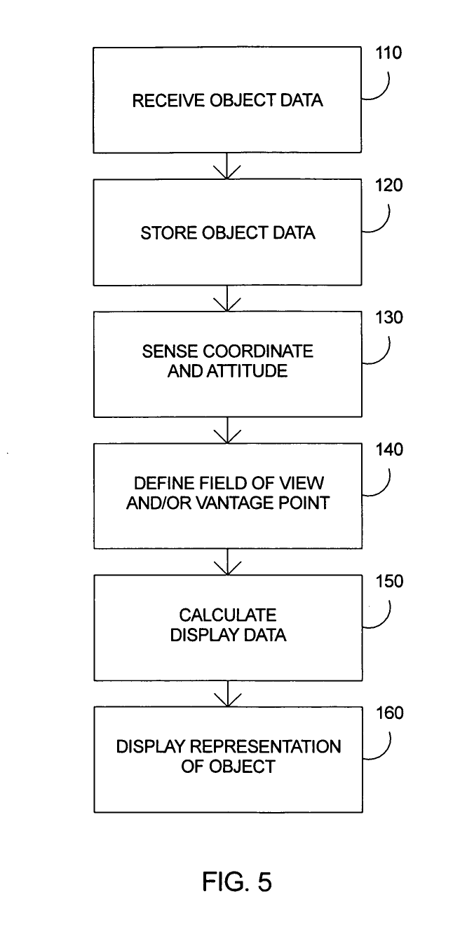

FIG. 5 depicts a second embodiment, a method of using personal viewing device 10 (FIG. 2). The personal viewing device 10 includes display 14 (FIG. 2). At 130 (FIG. 5), the method includes sensing a coordinate VP (FIG. 1) and an attitude P (FIG. 1) of personal viewing device 10. At 150 (FIG. 5), the method further includes calculating display data based on stored object data, the coordinate and the attitude. At 160 (FIG. 5), the method further includes displaying on display 14 (FIG. 2) a representation of the object in response to the display data.

In an example of second embodiment, the attitude is fixed in attitude direction P (e.g., see FIG. 3) and the sensing (130 of FIG. 5) includes sensing coordinate VP in no more than a single dimension (e.g., along the fix attitude P).

In a second example (e.g., see FIG. 4) of second embodiment, the sensing (130 of FIG. 5) includes sensing coordinate VP in no more than two dimensions (e.g., x, y) and sensing the attitude P about no more than one axis (e.g., roll Ø about a line orthogonal to an x, y plane). For instance, in FIG. 4, the coordinate sensed is depicted as coordinate VP (which extends to viewing area 230 of display 14 but is shown shorter for clarity) and the sensed attitude P is depicted by roll angle Ø about a line orthogonal to an x, y plane. A representation of the object (e.g., virtual object 220 extending to form the virtual world) is displayed on viewing area 230 of display 14 in response to the display data.

In a third example of second embodiment, the sensing (130 of FIG. 5) includes sensing the coordinate in three dimensions (e.g., x, y and z) and sensing the attitude about three axes (e.g., yaw, pitch and roll).

In a fourth example of second embodiment, the coordinate includes a two-dimensional coordinate (e.g., x, y or r, θ) and the attitude includes a two-component attitude (e.g., pitch and yaw).

In a fifth example of second embodiment, the coordinate includes a three-dimensional coordinate (e.g., x, y and z) and the attitude includes a three-component attitude (e.g., yaw, pitch and roll).

In a sixth example of second embodiment, the method further includes receiving object data (110 of FIG. 5) and storing the object data (120 of FIG. 5) in the personal viewing device to constitute the stored object data.

In a seventh example of second embodiment, the method further includes defining (140 of FIG. 5) a field of view FOV (FIG. 1). The calculating (150 of FIG. 5) includes computing the display data based on field of view FOV and from a point of view located at coordinate VP (FIG. 1) looking along a line of sight defined by attitude P (FIG. 1).

In an eighth example of second embodiment, the method further includes defining a vantage point VP (FIG. 1) along a line of sight that passes through coordinate VP and that is defined by attitude P (FIG. 1). The calculating (150 of FIG. 5) includes computing the display data to represent the stored object data as viewed from the vantage point looking along the line of sight.

There are many application for such a personal viewing device. Some these applications include:

navigating a large area 2D computer desktop;

navigating a large volume computer filing system;

navigating computer network graphs (information networks such as bio-informatics);

viewing and editing of 2D drawings, paintings and maps;

viewing and editing of 3D drawings, sculptures and terrain maps;

volumetric imaging (going inside a volume) of medical scans (NMRI, 3D ultrasound); and

volumetric imaging of computational model or gathered data.

Having described exemplary embodiments of a novel personal viewing device and method of using the device (which are intended to be illustrative and not limiting), it is noted that modifications and variations can be made by persons skilled in the art in light of the above teachings. It is therefore to be understood that changes may be made in the particular embodiments of the invention disclosed which are within the scope of the invention as defined by the appended claims.

Having thus described the invention with the details and particularity required by the patent laws, what is claimed and desired protected by Letters Patent is set forth in the appended claims.

What is claimed is:

1. A method of using a personal viewing device comprising a display, the method comprising:
sensing a coordinate and an attitude of the personal viewing device;
calculating display data based on stored object data, the coordinate and the attitude; and
displaying on the display a representation of the object in response to the display data.

2. A method according to claim 1, wherein:
the sensing comprises sensing the coordinate in no more than a single dimension; and
the attitude is fixed.

3. A method according to claim 1, wherein the sensing comprises:
sensing the coordinate in no more than two dimensions (x, y); and
sensing the attitude about no more than one axis (roll).

4. A method according to claim 1 wherein the sensing comprises:
sensing the coordinate in three dimensions (x,y,z); and
sensing the attitude about three axes (yaw, pitch and roll).

5. A method according to claim 1, wherein:
the coordinate comprises a two-dimensional coordinate; and
the attitude comprises a two-component attitude.

6. A method according to claim 1, wherein:
the coordinate comprises a three-dimensional coordinate; and
the attitude comprises a three-component attitude.

7. A method according to claim 1, further comprising:
receiving object data; and
storing the object data in the personal viewing device to constitute the stored object data.

8. A method according to claim 1, wherein:
the method further comprises defining a field of view; and
the calculating comprises computing the display data based on the field of view and from a point of view located at the coordinate looking along a line of sight defined by the attitude.

9. A method according to claim 1, wherein:
the method further comprises defining a vantage point along a line of sight that passes through the coordinate and that is defined by the attitude; and
the calculating comprises computing the display data to represent the stored object data as viewed from the vantage point looking along the line of sight.

10. A personal viewing device comprising:
a sensor operable to sense a coordinate and an attitude of the personal viewing device;
a processor operable to calculate display data in response to stored object data representing an object, the coordinate and the attitude, and
a display coupled to the processor operable to display an image of the object based on the display data.

11. A personal viewing device according to claim 10, wherein:
the coordinate is a single dimension coordinate; and
the attitude is fixed.

12. A personal viewing device according to claim 10, wherein:
the coordinate is a coordinate in no more than two dimensions (x, y); and
the attitude is a rotation metric about no more than one axis (roll).

13. A personal viewing device according to claim 10, wherein:
the coordinate is a coordinate in three dimensions (x,y,z); and
the attitude is a rotation metric about three axes (yaw, pitch and roll).

14. A personal viewing device according to claim 10, wherein:
the coordinate comprises a two-dimensional coordinate; and
the attitude comprises a two-component attitude.

15. A personal viewing device according to claim 10, wherein:
the coordinate comprises a three-dimensional coordinate; and
the attitude comprises a three-component attitude.

16. A personal viewing device according to claim 10, wherein the processor includes circuitry operable to receive object data and a memory operable to store the object data as the stored object data.

17. A personal viewing device according to claim 10, wherein:
the processor is further operable to define a field of view; and
the processor that is operable to calculate display data is operable to compute the display data in response to the field of view and from a point of view located at the coordinate looking along a line of sight defined by the attitude.

18. A personal viewing device according to claim 10, wherein:
the processor is further operable to define a vantage point along a line of sight that passes through the coordinate and that is defined by the attitude; and
the processor that is operable to calculate display data is operable to compute the display data to represent the stored object data as viewed from the vantage point looking along the line of sight.

19. A computer-readable medium in which is fixed a program that instructs a processor to perform a method of using a personal viewing device to display a view of an object represented by stored object data, the method comprising:
sensing a coordinate and an attitude of the personal viewing device;
calculating display data based on the stored object data, the coordinate and the attitude; and
displaying on a display a representation of the object in response to the display data.

20. A computer-readable medium according to claim 19, wherein:
the sensing comprises sensing the coordinate in no more than a single dimension; and
the attitude is fixed.

21. A computer-readable medium according to claim 19, wherein the sensing comprises:
sensing the coordinate in no more than two dimensions (x, y); and
sensing the attitude about no more than one axis (roll).

22. A computer-readable medium according to claim 19, wherein the sensing comprises:
sensing the coordinate in three dimensions (x,y,z); and
sensing the attitude about three axes (yaw, pitch and roll).

23. A computer-readable medium according to claim 19, wherein:
the coordinate comprise a two-dimensional coordinate; and
the attitude comprise a two-component attitude.

24. A computer-readable medium according to claim 19, wherein:
the coordinate comprises a three-dimensional coordinate; and
the attitude comprises a three-component attitude.

25. A computer-readable medium according to claim 19, the method further comprising:
receiving object data; and
storing the object data in the personal viewing device to constitute the stored object data.

26. A computer-readable medium according to claim 19, wherein:
the method further comprises defining a field of view; and
the calculating comprises computing the display data based on the field of view and from a point of view located at the coordinate looking along a line of sight defined by the attitude.

27. A computer-readable medium according to claim 19, wherein:
the method further comprises defining a vantage point along a line of sight that passes through the coordinate and that is defined by the attitude; and
the calculating comprises computing the display data to represent the stored object data as viewed from the vantage point looking along the line of sight.
